(19) United States
(12) Patent Application Publication
(10) Pub. No.: US 2026/0257091 A1
(43) Pub. Date: Sep. 3, 2026

(54) AEROSOL AIR MULTIPLEXER

(71) Applicant: NERO ENDÜSTRI SAVUNMA SANAYI ANONIM SIRKETI, Ankara (TR)

(72) Inventor: ALICAN ÖKÇÜN, Ankara (TR)

(73) Assignee: NERO ENDÜSTRI SAVUNMA SANAYI ANONIM SIRKETI, Ankara (TR)

(21) Appl. No.: 18/713,199

(22) PCT Filed: Aug. 9, 2023
(86) PCT No.: PCT/TR2023/050794

§ 371 Date: May 24, 2024

(30) Foreign Application Priority Data
Aug. 16, 2022 (TR) 2022/012921

(51) Int. Cl. A62C 5/00

(52) U.S. Cl. CPC A62C 5/008

(57) ABSTRACT

The present invention relates to an aerosol air multiplexer, which is used in aerosol fire extinguishing systems and exhausts, which reduces the temperature of the air created by the aerosol in the aerosol fire extinguishing systems, as well as the air temperature in the exhausts.

### TECHNICAL FIELD

The present invention relates to an aerosol air multiplexer used in aerosol fire extinguishing systems and exhausts.

In particular, the present invention relates to an aerosol air multiplexer, which reduces the temperature of the air created by the aerosol in the aerosol fire extinguishing systems, as well as the air temperature in the exhausts.

### STATE OF THE ART

The aerosol fire extinguishing system is basically a system consisting of liquid or solid particles suspended in the air in the environment. The heat of combustion is reduced by absorbing the heat in the environment, and thus physical rotation is provided with the cooling of the environment with the help of the aerosol fire extinguishing system.

In the aerosol fire extinguishing systems, the air temperature created by the aerosol is about 350-450° C., and the air temperature coming out from the end of the aerosol fire extinguishing systems is up to 600° C. In the state of the art, heat absorption materials such as alumina balls or metal parts etc. are used so as to reduce the air temperature caused by the aerosol, and the outgoing air is tried to be cooled.

However, the air temperature cannot be lowered below 50-100° C. with these applications. In order to reduce the air temperature below 500° C., it is necessary to use a large amount of the aforementioned materials and this increases the cost. Furthermore, at least 30 cm gap is left at the ends of the aerosol fire extinguishing systems, preventing the system from damaging any part for the aforementioned applications.

However, even if the aerosol fire extinguishing system works, effective operation cannot be achieved due to the temperature in the front. Due to the dispersion of the balls used at the end of the aerosol fire extinguishing systems or the disintegration of the coolers, there is a direct flame exit from the end and causes the environment to burn.

Therefore, the usability and effectiveness of aerosol fire extinguishing systems in homes or vehicles are decreasing.

Therefore, a need has arisen for a structuring that eliminates the problems experienced in aerosol fire extinguishing systems in the state of the art.

The document CN216603880 can be cited as an example of the state of the art in the literature research. Said document relates to the mechanical pressure relief port of the hot aerosol fire extinguisher. In the aforementioned invention, a fire extinguishing ignition system is mentioned.

Document No JP2011062339A can be shown as another example to the state of the art. Said document relates to solid aerosol that can be used to extinguish the fire during a fire. In the aforementioned invention, a system related to the slow burning of the fire extinguishing system is mentioned.

In both documents mentioned above, a system that allows reducing the temperature of the air by multiplexing could not be provided in aerosol fire extinguishing systems.

As a result of the aforementioned issues and the limited supply of available solutions, it became necessary to carry out an improvement in the relevant technical field.

### AIM OF THE INVENTION

The present invention relates to an aerosol air multiplexer which eliminates the abovementioned disadvantages and brings new advantages to the relevant technical field.

The main aim of the present invention is to reveal an aerosol air multiplexer, which reduces the temperature of the air created by the aerosol in the aerosol fire extinguishing systems, as well as the air temperature in the exhausts.

An aim of the present invention is to reveal an aerosol air multiplexer, which is placed inside the aerosol fire extinguishing systems, which cools the air by reducing the air temperature below 100° C., and makes it possible to operate the system without damaging any object at a distance of 0 cm from the nozzle outlet, without causing the risk of fire again.

Another aim of the present invention is to reveal an aerosol air multiplexer that allows the volume of the system to be reduced by placing it directly at the end of the aerosol fire extinguishing systems without placing aluminum balls or coolers, and eliminates the risk of the aerosol causing a fire to other equipment.

Another aim of the present invention is to provide aerosol fire extinguishing systems usable in the environment where people are present.

In order to fulfil all the purposes mentioned above and which may arise from the detailed description, the present invention is an aerosol air multiplexer used in aerosol fire extinguishing systems and exhausts, comprising the following;
air apparatus which is connected to the end of the aerosol generator body in the aerosol fire extinguishing system and directs the hot air coming out of the aerosol generator body,
outer sheath, which is connected to the lower end of the air apparatus and which is directed from the air apparatus and allows the hot air passing through it to be cooled and discharged to the environment as cold air,
an inner pipe that is located in the outer sheath and provides cooling by means of the interaction of the air passing through it and the hot air in the outer sheath.

The structural and characteristic features of the present invention will be understood clearly by the following drawings and the detailed description made with reference to these drawings. Therefore the evaluation shall be made by taking these figures and the detailed description into consideration.

### FIGURES CLARIFYING THE INVENTION

FIG. 1: a view of the inventive aerosol air multiplexer

### DESCRIPTION OF THE PART REFERENCES

10. Aerosol generator body
20. Air apparatus
30. Outer sheath
40. Inner pipe
50. Rear cover
100. Hot air
200. Cold air

### DETAILED DESCRIPTION OF THE INVENTION

In this detailed description, the preferred alternatives of the inventive aerosol air multiplexer are described only for clarifying the subject matter such that no limiting effect is created.

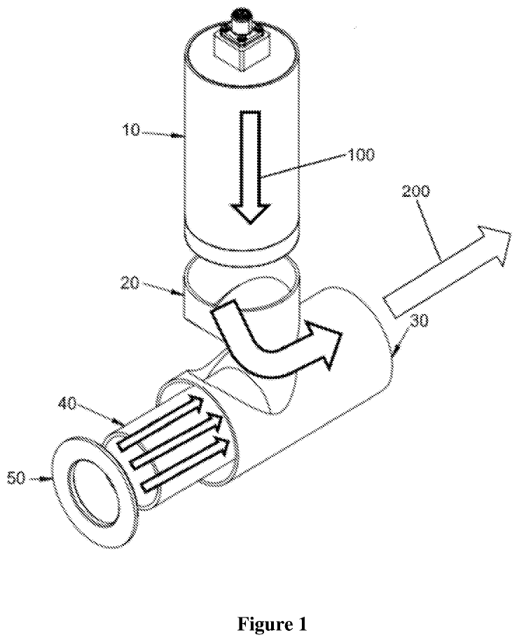

In FIG. 1, a view of the inventive aerosol air multiplexer is given. Accordingly, the aerosol air multiplexer comprises the following in its most basic form; aerosol generator body (10) which explodes in case of fire and creates compressed air, air apparatus (20) which is connected to the end of the aerosol generator body (10) and directs the hot air (100) of 450-500° C. coming out of the aerosol generator body (10), outer sheath (30), which is connected to the lower end of the air apparatus (20) and which allows the hot air (100) passing through it by being directed from the air apparatus (20) to be cooled to 100° C. and discharged into the environment as cold air (200), inner pipe (40), which is located in the outer sheath (30) and provides cooling through the interaction of the air at 25° C. passing through it and the hot air (100) passing through the outer sheath (30), rear cover (50) located at the end of the inner pipe (40) and providing air inlet at 25° C. to the inner tube (40).

The aerosol air multiplexer, which is the subject of the invention, is used at the end of the aerosol generator body (10), which forms the main structure of the aerosol fire extinguishing system. For this purpose, an air apparatus (20) is connected to the end of the aerosol generator body (10). Said air apparatus (20) provides direction to the hot air (100) of 450-500° C. coming out of the aerosol generator body (10).

450-500° C. hot air (100) coming out of the aerosol generator body (10) is directed into the outer sheath (30), which is connected to the lower end of the air apparatus (20). Said outer sheath (30) ensures that the hot air (100) passing through it is cooled to 100° C. and discharged to the environment as cold air (200).

The cooling process in the outer sheath (30) is provided by the inner tube (40) located in the outer sheath (30). Air at a temperature of 25° C. is passed through the inner pipe (40), and thus the hot air (100) inside the outer sheath (30) is cooled by interacting with the air at 25° C. inside the inner pipe (40).

The cold air (200) cooled to 100° C. is also discharged.

There is a rear cover (50) at the end of the inner pipe (40) that provides air inlet to the inner pipe (40) at a temperature of 25° C.

There is a rear cover (50) at the end of the inner pipe (40) that provides air inlet to the inner pipe (40) at a temperature of 25° C.

The operating principle of the aerosol air multiplexer, which is the subject of the invention, is as follows;

Compressed air generated by the explosion of the aerosol generator body (10) is directed to the outer sheath (30) by means of the air apparatus (20). Meanwhile, the hot air (100) entering from the rear cover (50) passes through the outer sheath (30) and interacts with the air at 25° C. in the inner pipe (40). Thus, the hot air (100) is discharged from the outer sheath (30) as cold air (200) at 100° C. The cooling process takes place within 5 seconds.

1. Aerosol air multiplexer used in aerosol fire extinguishing systems and exhausts, characterized in that, it comprises the following;
air apparatus (20) which is connected to the end of the aerosol generator body (10) in the aerosol fire extinguishing system and directs the hot air (100) coming out of the aerosol generator body (10),
outer sheath (30), which is connected to the lower end of the air apparatus (20) and which is directed from the air apparatus (20) and allows the hot air (100) passing through it to be cooled and discharged to the environment as cold air (200),
an inner pipe (40) that is located in the outer sheath (30) and provides cooling by means of the interaction of the air passing through it and the hot air (100) in the outer sheath (30).

2. Aerosol air multiplexer according to claim 1, characterized in that; it comprises a rear cover (50) located at the end of said inner pipe (40) and providing air inlet to the inner pipe (40) at a temperature of 25° C.
